(19) United States
(12) Patent Application Publication
(10) Pub. No.: US 2026/0350176 A1
(43) Pub. Date: Nov. 5, 2026

(54) SYSTEM AND METHOD FOR SECURING SOFTWARE SUPPLY CHAINS

(71) Applicant: ACCENTURE GLOBAL SOLUTIONS LIMITED, Dublin 4 (IE)

(72) Inventors: Vikrant KAULGUD, Bangalore (IN); Teresa Sheausan TUNG, Los Angeles, CA (US); Adam Patten BURDEN, Tampa, FL (US); Kuntal DEY, Birbhum (IN); Samarth SIKAND, Jaipur (IN); Kapil SINGI, Bangalore (IN); Vibhu Saujanya SHARMA, Bangalore (IN)

(73) Assignee: ACCENTURE GLOBAL SOLUTIONS LIMITED, Dublin 4 (IE)

(21) Appl. No.: 19/195,025

(22) Filed: Apr. 30, 2025

(51) Int. Cl. G06F 21/57; G06F 8/77

(52) U.S. Cl. CPC G06F 21/577; G06F 8/77; G06F 2221/033

(57) ABSTRACT

System and method for securing software supply chains is disclosed. The method includes receiving input data associated with a software project from a plurality of data sources, generating a knowledge graph for the received input data based on a pre-stored historical data, extracting sub-graphs from the knowledge graph by parsing relationships between the plurality of nodes, transforming the extracted sub-graphs into a plurality of prompts for a Large Language Model (LLM), computing a vulnerability score for the plurality of prompts based on a vulnerability, a severity, and a frequency of occurrence of a probabilistic vulnerable template in historical software projects and a probability of the vulnerability occurring, extracting probabilistic vulnerable templates corresponding to the plurality of prompts based on the computed vulnerability score, creating a customized priority pipeline for the extracted probabilistic vulnerable templates, selecting at least one vulnerable template with a highest vulnerability score based on probabilistic functions generating code snippets or recommendations for the received input data based on the selected at least one vulnerable template, and outputting the generated code snippets to a software development environment.

### FIELD OF THE INVENTION

The present disclosure generally relates to the field of software development, and more particularly to a system and a method for securing software supply chains built using artificially intelligent assistance.

### BACKGROUND

In contemporary software engineering, the integrity and security of software supply chains have emerged as critical priorities across industries. With the advent of AI-assisted software development, the lack of comprehensive governance over supply chains has introduced significant challenges, including increased vulnerability to threats and inconsistencies in managing dependencies. The reliance on advanced data-driven techniques to identify, predict, and mitigate vulnerabilities within complex systems is essential. Addressing these challenges underscores the pressing need for robust methodologies capable of securing software components while supporting scalable and efficient operations.

### SUMMARY

Implementations of the present disclosure are generally directed to securing supply chains for software development. Specifically, implementations are directed to securing supply chains for software built using artificially intelligent assistance. Such implementations include generation of software development tasks by integrating historical data, generating knowledge graphs, and utilizing machine learning techniques to predict vulnerabilities. By extracting and analyzing relevant data from multiple sources, the system identifies high-risk components, generates secure code snippets, and produces vulnerability-free solutions that are integrated directly into the software development pipeline. This ensures a more secure and efficient software creation process, reducing risk and preventing potential vulnerabilities from being introduced in the development phase.

In general, innovative aspects of the subject matter described in this specification provide a system. The system includes, at least one processor and at least one non-transitory processor-readable medium storing instructions to be executed by the at least one processor. The at least one processor is configured to receive input data associated with a software project from a plurality of data sources and generate a knowledge graph for the received input data based on pre-stored historical data, with nodes representing tasks and associated components, including software packages and libraries. The processor extracts sub-graphs from the knowledge graph, parses relationships between the nodes, and transforms the sub-graphs into prompts for a Large Language Model (LLM). The processor computes a vulnerability score for the prompts based on a vulnerability, severity, and frequency of occurrence of a probabilistic vulnerable template in historical software projects and maps the vulnerability score to the nodes in the sub-graphs. Thereafter, the processor extracts probabilistic vulnerable templates corresponding to the prompts, creates a customized priority pipeline for the extracted templates, selects the highest vulnerability score template based on probabilistic functions, generates code snippets for the received input data corresponding to zero vulnerabilities, and outputs the generated code snippets to a software development environment.

The present disclosure further describes a method for securing supply chains for software development. The present disclosure also describes non-transitory processor readable storage medium coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure is not limited to the combinations of aspects and features specifically described herein but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 depicts an example environment that may be used to execute implementations of the present disclosure;

FIG. 2 depicts an example architecture of a system for securing supply chains for software development in accordance with implementations of the present disclosure;

FIG. 3A depicts a block diagram showing a process flow of securing supply chains for software development in accordance with implementations of the present disclosure;

FIG. 3B illustrates the process of generating the knowledge base, accordance with an embodiment of the present disclosure;

FIG. 3C illustrates the process of creating code snippets, in accordance with an embodiment of the present disclosure;

FIG. 3D illustrates the process of generating vulnerable clusters, in accordance with an embodiment of the present disclosure;

FIG. 4 is a flow diagram presenting an exemplary method in accordance with implementations of the present disclosure; and

FIG. 5 illustrates a computer system that may be used to implement the knowledge system.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, systems, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element. “First,” “second,” etc., are labels to distinguish components or blocks of otherwise similar names but does not imply any sequence or numerical limitation. “And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

The increasing reliance on artificial intelligence (AI) in software development has introduced transformative changes across the industry. AI-assisted tools and systems have enabled enhanced automation and optimization throughout various stages of the software development lifecycle, improving efficiency, scalability, and overall productivity. However, these advancements have also led to new challenges, particularly within the context of software supply chains. Traditional approaches for managing the security and integrity of these supply chains often struggle to address the complexities and evolving nature of modern AI-driven development environments, thereby creating new vulnerabilities and potential risks that are difficult to predict and mitigate using conventional methods.

Current solutions for managing software supply chain risks frequently rely on static, rule-based systems or traditional vulnerability detection techniques, which have proven insufficient in handling the dynamic and multifaceted nature of AI-assisted software development. These systems are often unable to adapt to the continuous changes in the software ecosystem or the evolving nature of potential threats. Additionally, they lack the granularity needed to identify, predict, and mitigate vulnerabilities effectively, especially in the context of AI-driven tools integrated into the development pipeline. As a result, critical vulnerabilities may go undetected, leading to compromised software security and reliability.

Furthermore, traditional vulnerability detection methodologies often depend heavily on exhaustive data collection and analysis, which can result in increased computational overhead and resource consumption. These systems typically process entire software graphs or large datasets without focusing on the most relevant or high-risk elements, reducing both their efficiency and effectiveness. Moreover, the solutions currently available in the market tend to generate overly broad and generic remediation suggestions, which lack the context necessary for effective decision-making. These shortcomings highlight the need for advanced systems capable of real-time vulnerability detection and mitigation, which can dynamically adapt to AI-assisted environments, ensuring the security and integrity of software supply chains.

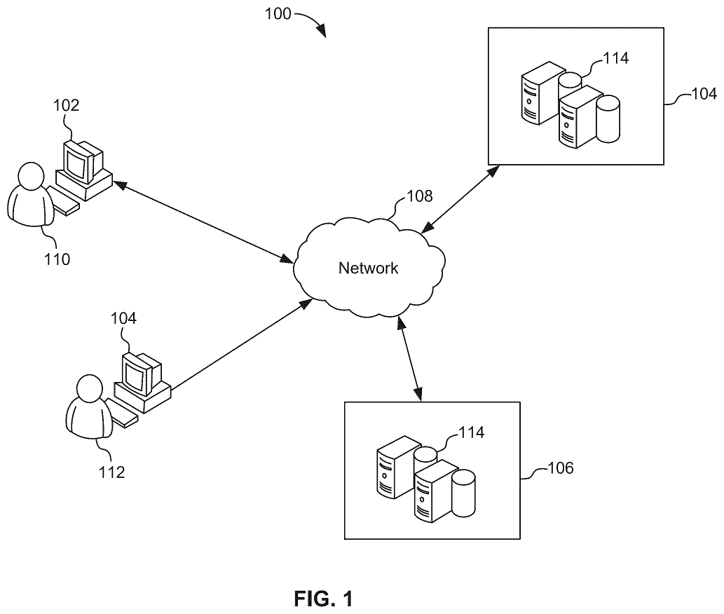

FIG. 1 depicts an example environment 100 that may be used to execute implementations of the present disclosure. In some examples, the example environment 100 enables securing supply chains for software development.

As depicted in FIG. 1, the example environment 100 includes computing devices 102 and 104, back-end systems 106, and a network 108. In some examples, the computing devices 102 and 104 are used by respective users 110 and 112 to log into and interact with computing platforms executing applications according to implementations of the present disclosure. Examples of the computing devices 102 and 104 may include desktop computing devices, smartphones, laptops, tablet, voice-enabled devices, and/or the like. It is contemplated that implementations of the present disclosure may be realized with any appropriate type of computing device. In some examples, each of the computing devices 102 and 104 may include a web browser application executed thereon, which may be used to display one or more web pages of a computing platform executing applications. In some examples, each of the computing devices 102 and 104 may display one or more Graphical User Interfaces (GUIs) that enable the respective users 110 and 112 to interact with the computing platform.

In some examples, the network 108 includes a Local Area Network (LAN), a Wide Area Network (WAN), the Internet, or a combination thereof, and connects web sites, the computing devices 102 and 104, and the back-end systems 106. In some examples, the network 108 may be accessed over a wired and/or a wireless communication link. For example, a computing device like smartphone may utilize a cellular network to access the network 108.

In some examples, one or more of the back-end systems 106 may be implemented as an on-premises system that is operated by an enterprise or a third-party engaged in cross-platform interactions and data management. In some examples, the back-end systems 106 may be implemented as an off-premises system (for example: cloud or on-demand) that is operated by an enterprise or a third-party on behalf of an enterprise. In some examples, one or more of the back-end systems 106 may be implemented in a cloud environment. For simplicity, the back-end systems 106 depicted in FIG. 1 may be a cloud environment that is intended to represent various forms of servers including a web server, an application server, a proxy server, a network server, a server pool, and/or the like.

In some examples, each of the back-end systems 106 includes one or more systems 114 to host components (for example, knowledge embeddings) for software development. Further, the system 114 accepts requests from the users 110 and 112 through the respective computing devices 102 and 104 for services being provided by the system 114. In response to the accepted requests, the system 114 provides the requested services to the computing devices 102 and 104 over the network 108. The requests received from the users 110 and 112 through the respective computing devices 102 and 104 may be user inputs for software development. The system 114 may enable a foundation model to accurately understand user inputs, thereby generating accurate software in response to user inputs. The interaction between the system 114 and users 110, 112 may be conversational in nature, including queries, inputs, as well as responses.

According to implementations of the present disclosure, the system 114 may be adapted for securing supply chains for software development built using artificially intelligent assistance by integrating historical data, generating a knowledge graph, and utilizing machine learning techniques to predict vulnerabilities. Numerous examples depicting the software generation with secure supply chains are described in detail in conjunctions with figures below.

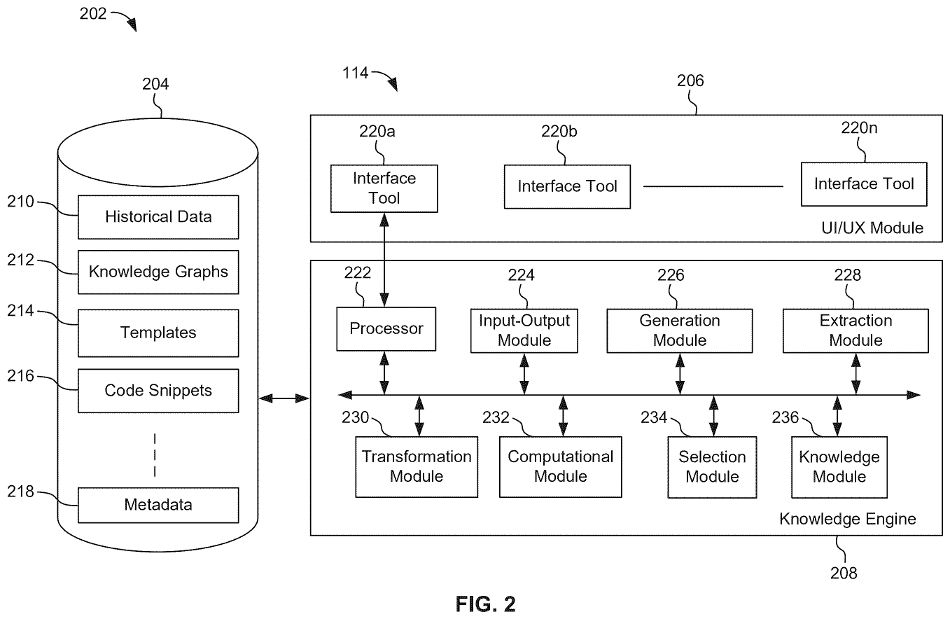

FIG. 2 depicts an example architecture 202 of the system 114 for securing software supply chains. As described, the software supply chains are secured during software development, particularly when a software project is being developed with assistance of foundation models, such as AI tools. In an example, as shown in FIG. 2, the system 114 receives input data associated with the software project from a plurality of data sources. The input data comprises multiple levels of tasks related to the software development supply chain, including tasks associated with software components, libraries, dependencies, and related elements. The plurality of data sources may include task-level information data source, software components, libraries, dependencies, and historical data from previous software projects. The input data, drawn from these diverse sources, is used to assess and manage risks within the supply chain by identifying potential vulnerabilities and dependencies that may impact the security and reliability of the software development process.

The system 114 includes a knowledge base 204, a User Interface (UI)/User Experience (UX) module 206, and a knowledge engine 208. The knowledge base 204 may be described as a structured repository or database associated with the knowledge system 114. The knowledge base 204 may incorporate various knowledge representation schemes, such as ontologies, taxonomies, or semantic networks, to encode and organize information in a machine-understandable format, thereby enabling advanced search, inference, and reasoning capabilities. Furthermore, the knowledge base 204 may leverage advanced technologies, including natural language processing, machine learning, and knowledge engineering techniques, to enhance knowledge acquisition, update, and refinement processes, ensuring its continual relevance and adaptability to evolving needs and circumstances.

In some implementations, the knowledge base 204 includes historical data 210, knowledge graphs 212, templates 214, code snippets 216, and metadata 218. The historical data 210 refers to past software project data that includes details on vulnerabilities, risk patterns, and successful mitigation strategies. The knowledge graphs 212 are dynamic structures that map relationships between various tasks and components within the software project, identifying potential vulnerabilities and risks. The knowledge graphs 212 are generated based on the received input data and are continuously refined using historical data 210 to provide accurate insights into task dependencies and associated security threats.

The templates 214 are structured patterns stored within the knowledge base 204, which help identify common vulnerabilities and risks in the software development supply chain. The templates 214 are derived from historical data 210 and used to map vulnerabilities to specific tasks and components, enabling efficient risk assessment and mitigation strategies. The code snippets 216 are pre-generated code sections designed to address common vulnerabilities identified within the software supply chain. When a vulnerability is detected through the knowledge graph, the code snippets 216 can be automatically selected and suggested to the developers to resolve the identified issues, ensuring secure code development.

The metadata 218 may be described as descriptive information about the various elements in the knowledge base 204, such as templates 214, knowledge graphs 212, and code snippets 216. The metadata 218 ensures the efficient retrieval and contextual understanding of these elements, enhancing the accuracy and relevance of the system 114's recommendations and actions.

In some implementations, the knowledge base 204 supports advanced capabilities by leveraging techniques from natural language processing and machine learning to enhance knowledge acquisition and refinement processes. This continual update and enhancement of the knowledge base ensure its relevance and effectiveness in meeting the dynamic requirements of the system 114.

The UI/UX module 206 may be defined as a module, which designs and manages a User Interface (UI), via which the user interacts with the system 114, and the User's Experience (UX) during said interaction. The UI/UX module 206 may integrate various technologies and frameworks to optimize visual layout, interactive elements, and overall usability, often utilizing principles of Human-Computer Interaction (HCI) and graphic design.

In some examples, the UI/UX module 206 may represent one or more front-end components/interfaces 222a-222n of a chatbot that may be executed on one or more of the computing devices 102 and 104 to enable receipt of the queries and responding to the same. In some examples, the query may be received through various modalities including, but not limited to, a question input to a chat bot, a request provided through a Graphical User Interface (GUI), an email, and/or the like.

The knowledge engine 208 may be configured to process and analyze the received input data from multiple data sources, enabling the system 114 to map the relationships between various tasks and associated components. This analysis allows for the identification of potential risks, vulnerabilities, and dependencies within the software supply chain. The knowledge engine 208 may leverage pre-stored historical data and knowledge graphs to generate insights, facilitating the detection of vulnerabilities and supporting the creation of customized priority pipelines for software components.

The knowledge engine 208 may rely on one or more machine learning models trained on a broad dataset of historical project data, enabling it to generate vulnerability scores for tasks and components within the software project. In some implementations, the one or more machine learning models may be implemented as probabilistic models. Such probabilistic models may be used to assess a likelihood of specific vulnerabilities, aiding in prioritization of tasks which require immediate attention. This allows the system 114 to identify potential vulnerabilities early in the development cycle. In other implementations, the one or more machine learning models may be implemented as artificial intelligent models, including but not limited to supervised learning models, unsupervised learning models, reinforcement learning models, and the like.

The knowledge engine 208 includes one or more processors 222, an input/output module 224, a generation module 226, an extraction module 228, a transformation module 230, a computational module 232, a selection module 234, and a knowledge module 236.

The processor 222 may include, for example, microprocessors, microcomputers, microcontrollers, digital signal processors, central processing units, state machines, logic circuits, and/or any devices that manipulate data or signals based on operational instructions. Among other capabilities, the processor 222 may fetch and execute computer-readable instructions in a memory operationally coupled with the knowledge system 114 for generating the extended chunks.

The input/output module 224 facilitates the interaction between the system 114 and external data sources or environments. It pertains to receiving input data associated with the software project and outputting generated code snippets to the software development environment. Specifically, the input/output module 224 receives input data from multiple data sources, including repositories, issue tracking systems, and software development tools. This input data comprises diverse elements such as tasks at various levels, associated components like software packages and libraries, and metadata. By aggregating this data, the module ensures a comprehensive understanding of the software project, enabling accurate analysis and processing.

Additionally, the input/output module 224 is responsible for outputting generated code snippets. These snippets are tailored to address identified vulnerabilities or optimize specific components in the software development process. By transmitting these outputs to the software development environment, the module facilitates seamless integration of the generated code into ongoing workflows, enhancing security and efficiency in the software supply chain.

The generation module 226 is configured to generate or create various elements essential for implementing the present disclosure. Specifically, the generation module 226 may be utilized to generate knowledge graphs, create priority pipelines, and generate code snippets. The generation module 226 generates knowledge graphs by analyzing the input data with respect to the historical data 210, metadata 218, and existing templates 214. These knowledge graphs represent the relationships between tasks, software components, and their interdependencies, aiding in identifying critical vulnerabilities and dependencies. The generation module 226 organizes this information into nodes and edges, where nodes represent entities like tasks or libraries, and edges represent the relationships or dependencies between them.

In addition to knowledge graphs, the generation module 226 creates priority pipelines for software development workflows. These pipelines are designed to optimize task execution by prioritizing critical actions based on calculated risk scores or dependency levels. For instance, the module may evaluate a set of interconnected tasks and determine an optimal sequence of execution to mitigate risks or enhance efficiency. Furthermore, the generation module 226 facilitates the creation of code snippets based on the identified requirements and relationships within the software development process.

The extraction module 228 pertains to identifying and isolating specific elements within the knowledge graph for further processing. The extraction module 228 identifies sub-graphs based on defined parameters, such as relationships between specific software components, tasks, or vulnerabilities. These sub-graphs represent clusters of interest, such as all tasks dependent on a particular library or all components affected by a specific vulnerability.

The extraction module 228 retrieves relevant data from the knowledge base 204, including associated metadata 218 and historical data 210, to provide context for these sub-graphs. For instance, in the case of a software library with known vulnerabilities, the extraction module 228 may extract a sub-graph that highlights all tasks or components relying on this library and their associated risk levels. In some instances, the extraction module 228 may filter and retrieve data to assist in vulnerability analysis. For example, the extraction module 228 may focus on extracting relationships with the highest risk scores or dependencies most critical to the software supply chain, enabling efficient prioritization for further processing.

The transformation module 230 is configured to convert extracted sub-graphs and associated data into formats suitable for subsequent analysis or action. Specifically, the transformation module 230 may process these sub-graphs into prompts, workflows, or other structured outputs to facilitate deeper analysis or actionable recommendations. For instance, the transformation module 230 may reformat a sub-graph of tasks and their dependencies into a priority list that highlights critical vulnerabilities requiring immediate attention. Similarly, the module may transform metadata and dependency relationships into templates or guidelines for addressing specific risks. In some examples, the transformation module 230 adapts the extracted sub-graphs to integrate them with external tools or systems.

The computational module 232 pertains to the evaluation and analysis of extracted data to compute metrics or scores relevant to the software development process. Specifically, the computational module 232 computes vulnerability scores for identified tasks, components, or prompts based on their associated risks, severity, and frequency of occurrence. The computational module 232 analyzes the relationships and metadata within the extracted sub-graphs to assess potential vulnerabilities. By leveraging historical data 210 and probabilistic templates, it calculates a vulnerability score for each node or cluster within the knowledge graph. This score reflects the likelihood, impact, and recurrence of specific vulnerabilities, enabling precise prioritization of actions to mitigate risks.

In some instances, the computational module 232 may utilize advanced statistical models or machine learning algorithms to enhance the accuracy of its computations. For example, it may employ probabilistic functions to account for uncertainties in the data, ensuring robust and reliable scoring mechanisms. These computed scores are then mapped back to the nodes in the sub-graphs, providing a clear visualization of vulnerabilities across the supply chain.

The selection module 234 is configured to identify and prioritize elements within the processed data for further action. Specifically, the selection module 234 selects at least one vulnerable template with the highest vulnerability score, indicating the most critical risk to the software supply chain. The selection module 234 parses the computed vulnerability scores generated by the computational module 232 to rank the identified vulnerabilities. It employs probabilistic functions to evaluate these scores, ensuring that the selected templates accurately represent the highest level of detected risks. In some examples, the selection module 234 may also consider contextual factors, such as dependencies or the availability of alternate components, when prioritizing templates. For instance, a template associated with critical dependencies or lacking viable alternatives may receive higher priority, guiding targeted actions to mitigate the associated risks.

The knowledge module 236 facilitates the integration of insights derived from the knowledge graph 212 and associated computations into actionable outputs. The knowledge module 236 maps the generated code snippets to a plurality of Software Bill of Materials (SBOM) formats, including XML, JSON, and YAML, ensuring compatibility across diverse software development frameworks. The knowledge module 236 further generates recommendations for the code snippets based on the stage of the Software Development Life Cycle (SDLC), addressing specific requirements such as security enhancements during development or performance optimizations during deployment. In addition, the knowledge module 236 dynamically generates updates to the SBOM, incorporating the secure code snippets aligned with the generated recommendations. This functionality ensures that the software development process remains efficient and secure while maintaining consistency with the evolving requirements of the supply chain.

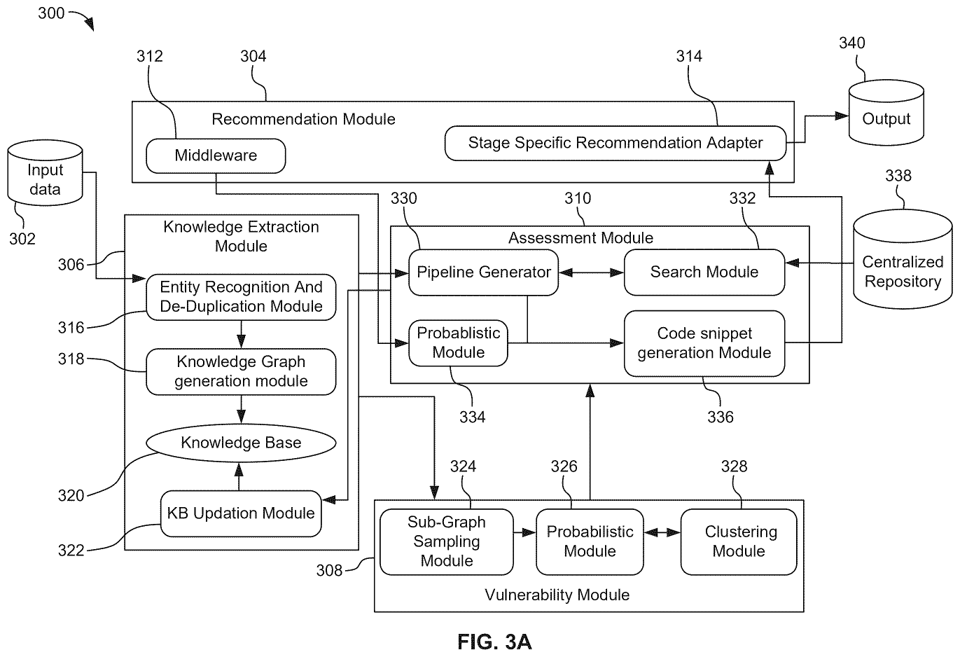

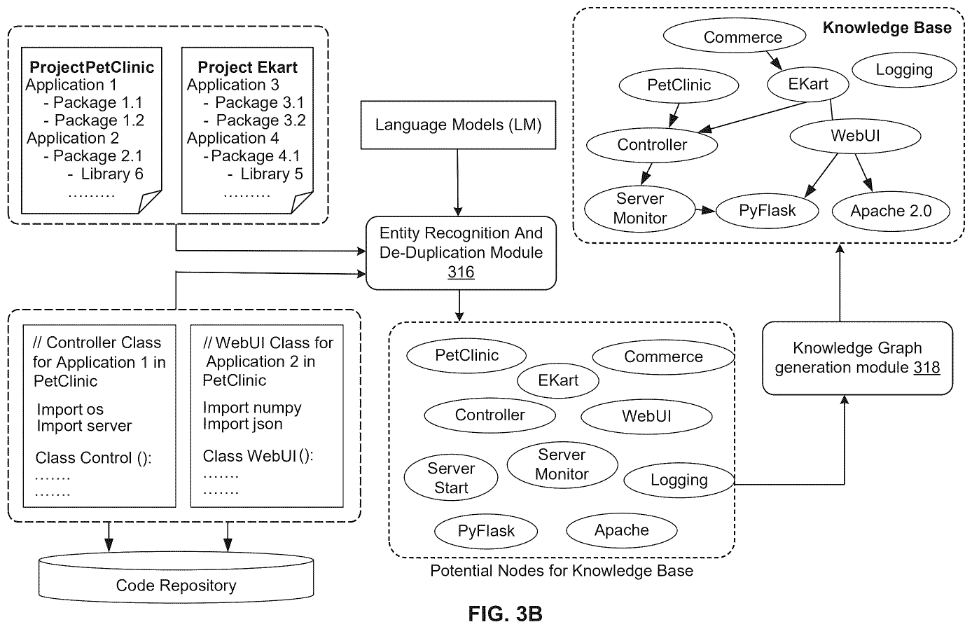

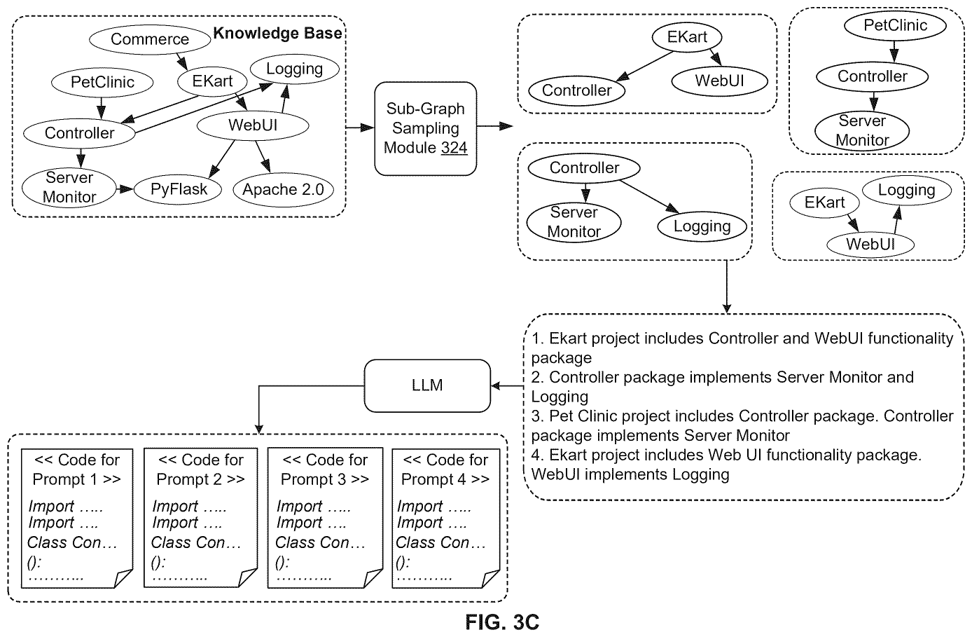

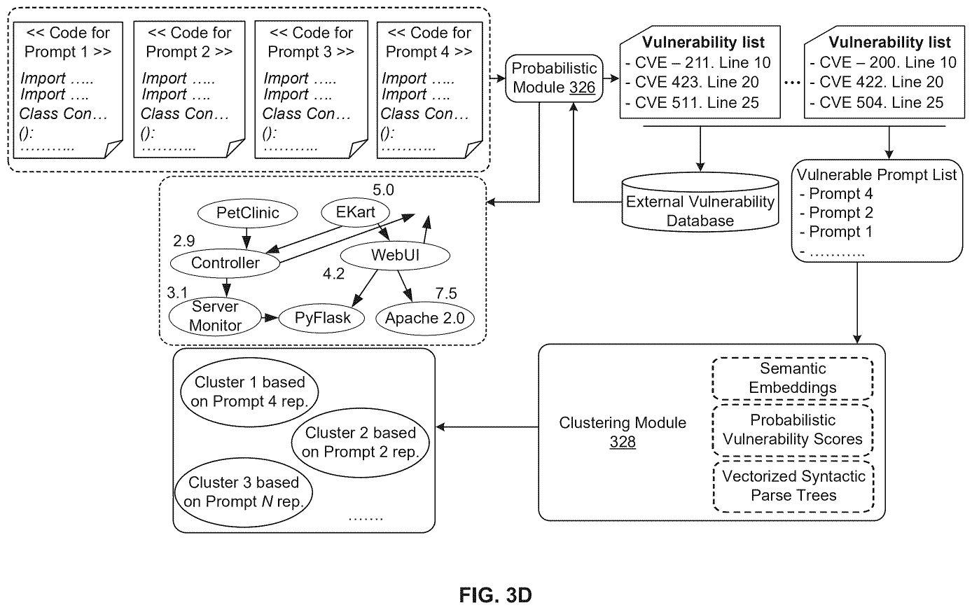

FIG. 3A depicts a block diagram showing a process flow 300 for securing supply chains in accordance with implementations of the present disclosure.

As shown in the figure, input data 302 is provided to a knowledge extraction module 306 associated with the system 114. The knowledge extraction module 306 refers to a component configured for extracting knowledge from various data sources (ideally within the software supply chain) for securing the supply chain. The knowledge extraction module 306 processes a wide range of input data, such as historical data, software component metadata, and task-level details, to construct knowledge that can inform decision-making processes throughout the software development lifecycle. The knowledge extraction module 306 utilizes advanced data parsing techniques and algorithms to effectively mine and structure information, enabling the system 114 to identify potential vulnerabilities and associated risks within the supply chain.

The knowledge extraction module 306 includes an entity recognition and de-duplication module 316, a knowledge graph generation module 318, a knowledge base 320, and a knowledge base (KB) updation module 322. Specifically, the input data may be provided to the entity recognition and de-duplication module 316. The entity recognition and de-duplication module 316 identifies and categorizes entities within datasets while removing redundant or duplicate entries. Using techniques such as Natural Language Processing (NLP), the entity recognition and de-duplication module 316 extracts relevant entities and resolves conflicts to ensure data consistency and integrity. The module 316 enhances accuracy and reliability of downstream processes, streamlining data management and optimizing system performance. In one embodiment, the entity recognition and de-duplication module 316 uses the LLM models to extract entities from the input data and code repository. The extracted entities are then used for generating the knowledge graph.

The software project may refer to software being built, a structured initiative focused on the creation, development, and maintenance of software applications or systems to address specific requirements or challenges. The software project may typically involve defining objectives, managing resources, and overseeing workflows such as design, testing, deployment, and maintenance. Specifically, the software project may involve securing the software supply chain by identifying vulnerabilities, integrating security measures, and managing associated artifacts like Software Bill of Materials (SBOM) files and dependency mappings.

The input data comprises a plurality of levels of tasks associated with the software project. These tasks may range from high-level objectives, such as feature design and architectural planning, to more granular activities, such as coding, testing, and integration. Each level of tasks is interconnected and contributes to the overall workflow and progression of the software project, forming a hierarchical or networked representation of the development process.

In some instances, the levels of tasks may include strategic planning tasks at the topmost level, followed by system design and module development tasks at intermediate levels, and detailed implementation tasks, such as writing individual code snippets or performing unit tests, at the lower levels. These tasks are often accompanied by associated components, such as required software packages, libraries, or dependencies, which are essential for the execution and completion of the tasks. By organizing tasks across multiple levels, the input data provides a comprehensive representation of the software project's structure, enabling efficient analysis, management, and optimization of workflows.

Upon processing the input data, that is upon extracting the entities, the entity recognition and de-duplication module 316 shares entities with the knowledge graph generation module 318. In one embodiment, the knowledge graph generation module 318 is configured for creating structured representations of data that capture relationships and dependencies between various entities. By integrating data from multiple sources, the knowledge graph generation module 318 constructs a graph-based model that provides a comprehensive view of interconnected elements.

The knowledge graph generation module 318 generates a knowledge graph for the received input data based on pre-stored historical data. The knowledge graph refers to a structured representation of real-world entities and their relationships, often stored in a graph database. Typically, the knowledge graph comprises nodes representing entities and edges denoting relationships between these entities.

Specifically, the knowledge graph comprises a plurality of nodes representing the plurality of levels of tasks, and associated components, and the associated components comprise at least one of software packages and libraries. The associated components may include, but are not limited to, software packages and libraries, which are integral to the completion and execution of the tasks within the software project. Each node in the knowledge graph serves to establish the relationship between various components, thereby mapping dependencies and interactions across the software development lifecycle. This enables a comprehensive view of the software project, aiding in the identification and mitigation of potential vulnerabilities or inefficiencies.

The pre-stored historical data is a repository of historical data pertaining to software development, software bill of materials, previously identified vulnerabilities, and the like, which is collected and stored at a database associated with the system 114. Further, the pre-stored historical data may be communicated to and stored at the memory, at a time prior to implementation of this method.

As discussed, the pre-stored historical data comprises internal code repository and a historical Software Bill of Materials (SBOM). The historical SBOM refers to a documented record of the components, dependencies, and relationships involved in the development of software projects over time. Unlike a current SBOM, which reflects the present state of a software system, a historical SBOM tracks the evolution of software elements, including changes, updates, and deprecated components.

The historical SBOM provides detailed insights into past configurations of the software, enabling traceability for security audits, compliance checks, and the identification of vulnerabilities in legacy components. By maintaining this chronological record, the historical SBOM facilitates informed decision-making during software updates, enhances the ability to address historical security risks, and ensures alignment with industry regulations.

For generating the knowledge graph, the knowledge graph generation module 318 extracts the plurality of levels of tasks from the pre-stored historical data. In this regard, the knowledge graph generation module 318 extract the plurality of levels of tasks from the pre-stored historical data. High level tasks typically are comprised of low-level tasks. The knowledge graph generation module 318 may utilize a plurality of algorithms, for example, a Latent Dirichlet Allocation algorithm, or a language model (machine learning) algorithm to extract high level tasks. The knowledge graph generation module 318 may extract low level tasks by extracting descriptions of packages, libraries and third-party component used. Such components extracted while extracting the tasks, for example, descriptions of packages, libraries, and the like, are referred to as associated components.

The knowledge graph generation module 318 utilizes the plurality of levels of tasks, as well as the associated components to create the plurality of nodes of the knowledge graph. In this regard, nodes regarding the software project, having product names may be created, assisting in tracking usage of libraries within past projects. Various other nodes related to different concepts, for example, programming language, industry domain, and the like, may also be created.

Further, the knowledge graph generation module 318 generate relationships between the created plurality of nodes by correlating each of the plurality of levels of tasks with the associated components. The knowledge graph generation module 318 may establish relationships between the created plurality of nodes by leveraging contextual data to define task-component associations.

Notably, the pre-stored historical data comprises an internal code repository and the historical Software Bill of Materials (SBOM). The internal code repository refers to a secure, centralized storage system within an organization, used for managing, organizing, and maintaining codebase versions developed during software projects. This repository typically includes proprietary source code, configuration files, libraries, and documentation required for the development and maintenance of software applications. Advantageously, the internal code repository enables collaborative development by providing controlled access to team members, facilitating version control, and ensuring traceability of changes through features such as commit histories and branching.

Thereafter, the knowledge graph generation module 318 generates the knowledge graph for the received input data based on generated relationships and the created plurality of nodes. The knowledge graph may be stored at the knowledge base 320. The knowledge graph may be appended with information regarding versions of packages used either as node attributes or separate nodes. The knowledge graph generation module may utilize a custom rule-based algorithm to generate the entire Knowledge graph. Further, the knowledge base may be stored in a graph database (e.g., Neo4j), i.e., the knowledge base 320 may be implemented as a graph database. FIG. 3B illustrates the process of generating the knowledge base, accordance with an embodiment of the present disclosure. As shown, the entity recognition and de-duplication module 316 uses the input data and the internal code repository and the historical Software Bill of Materials (SBOM) to extract the entities. Then the knowledge graph generation module 318 uses the extracted entities to generate the knowledge graph and the knowledge graph is stored in the knowledge base 320.

The knowledge extraction module 306 is communicably coupled to a vulnerability module 308. In this regard, components of the vulnerability module 308 may access and utilize the knowledge graph stored at the knowledge base 320 within the knowledge extraction module 306. The vulnerability module 308 identifies, analyzes, and prioritizes potential security weaknesses within the software supply chain by evaluating tasks, associated components, and their interdependencies for exposure to risks or threats.

The vulnerability module 308 comprises a sub graph sampling module 324, a probabilistic module 326, and a clustering module 328. The sub graph sampling module 324 extracts sub-graphs from the knowledge graph by parsing relationships between the plurality of nodes. Sub-graphs refer to distinct subsets of nodes and edges that represent specific, localized relationships or clusters of information within an overall structure of the knowledge graph. Specifically, the sub-graphs represent a plurality of clusters of tasks and the associated components.

In this regard, the sub graph sampling module 324 identifies clusters within the knowledge graph by grouping the plurality of nodes based on a task similarity and a component relevance. Task similarity is determined by analyzing shared characteristics or dependencies between tasks, while component relevance is assessed based on the association and utility of components for achieving task-specific goals. Each cluster corresponds to a sub-graph and represents the plurality of levels of tasks and the associated components, enabling a focused analysis of interconnected elements within the knowledge graph.

In one embodiment, the sub graph sampling module 324 generate the sub-graphs using probabilistic paths. Probabilistic paths refer to sequences of interconnected nodes within the knowledge graph that are associated with varying probabilities, reflecting the likelihood of traversal based on factors such as task dependencies, historical data, or contextual relevance. The probabilistic paths are generated by traversing the knowledge graph based on transition probabilities, such that the transition probabilities correspond to functions of a current node, previously traversed nodes, and candidate nodes.

In another embodiment, the sub graph sampling module 324 may utilize a sub-sampling function to extract multiple sub-graphs. Further, the sub graph sampling module 324 may utilize a constraint while extracting the sub-graph which stipulates that a quality of the sub-graph post processing should be above a certain metric threshold.

Thereafter, the sub graph sampling module 324 applies a sub-sampling function to the generated sub-graphs from the knowledge graph. The sub-sampling function selectively reduces the size of the sub-graphs, focusing on the most relevant nodes and relationships while maintaining key contextual information. This helps optimize computational efficiency and ensures that the most significant aspects of the clustered tasks and components are preserved for further analysis.

The sub-graphs represent clustered tasks and components. Each sub-graph groups tasks and their associated components, such as software packages or libraries, that share similarities in terms of functionality, relevance, or relationship within the software development lifecycle. These clustered sub-graphs help refine the focus for vulnerability detection, prioritization, and mitigation.

Further, the sub graph sampling module 324 evaluates the extracted sub-graphs based on a predetermined quality metrics to compute an accuracy score and a completeness score. The accuracy score assesses the relevance and precision of the relationships and components within each sub-graph, ensuring that the extracted information accurately reflects the intended context and task dependencies from the knowledge graph. The completeness score measures how well the sub-graph represents the full spectrum of relationships and components defined in the knowledge graph, ensuring that no critical data or dependencies are omitted.

The completeness score may be measured as a function of a number of node types present in each sub-graph relative to the knowledge graph. This metric evaluates the diversity and depth of the components within the sub-graph, comparing the node types identified within the sub-graph to those defined in the knowledge graph. A higher number of node types indicates greater completeness, while a lower number may suggest that important components or task dependencies have been overlooked in the sub-graph.

In an example, the sampled sub-graph may be assessed for accuracy and completeness. A completeness score may be a function of number of unique node type present in the sampled sub-graph with respect to entire knowledge graph. In another example, generation of the sub-graphs follow probabilistic paths which combines random walks reinforced by feedback from the mentioned constraint. Random walks for knowledge graph may consist of traversing the graph based on transition probability. The transition probability may be a function of current node, previous traversed nodes and potential candidate nodes.

In one embodiment, upon generating the sub-graph, the sub graph sampling module 324 transforms the extracted sub-graphs into a plurality of prompts for a Large Language Model (LLM). This transformation involves converting the relevant data and relationships within the sub-graphs into specific query-based prompts that are tailored for processing by the LLM. The sub-graphs, which contain clustered tasks and components, are distilled into concise instructions that can guide the LLM in generating meaningful responses.

The plurality of prompts is transformed into natural language statements, enabling the LLM to understand and process them as human-readable queries. This conversion ensures that the LLM can efficiently analyze the prompts, extract relevant insights, and generate responses that align with the context and goals of the software development process, such as vulnerability detection or prioritization of tasks.

Further, the natural language statements are passed to a foundation model (for example, a generative artificially intelligent model, a large language model, or the like) to generate code snippets. These code snippets are passed through one or more static vulnerability tools to detect any vulnerabilities (i.e., issues or bugs).

For transforming the extracted sub-graphs, the sub graph sampling module 324 encodes the extracted sub-graphs into vectorized representations using a pre-trained Graph Neural Networks (GNNs). The GNN is capable of capturing the structure and relationships within the sub-graphs, generating high-dimensional vector representations that encapsulate the semantic and relational information of the nodes and edges within the sub-graphs. In an example, the sub-graphs sampled from the exhaustive knowledge graph are transformed into natural language (NL) statements based on evaluation of their quality, such as by measuring perplexity.

The vectorized representations are processed using a pipeline of transformer-based language models, which are designed to convert the encoded representations into natural language statements. The transformer models use attention mechanisms to capture the contextual relationships in the data, facilitating the generation of coherent and contextually accurate natural language outputs based on the graph-derived information.

The sub graph sampling module 324 validates the encoded vectorized representations using a Natural Language (NL)-specific metrics, comprising a fluency and a syntactic correctness. Fluency refers to the smoothness and coherence of the generated natural language output, ensuring that the statements read naturally and are easy to understand. Syntactic correctness involves ensuring that the generated statements follow the grammatical rules and structures of the target language. The sub-graph sampling module 324 applies these metrics to assess the quality of the generated NL statements, ensuring they are both linguistically sound and contextually appropriate, thereby enhancing the reliability and comprehensibility of the final outputs.

In some implementations, the natural language statements are validated using specific metrics, for example, perplexity. For example, a pre-trained Graph Neural Network (GNN) may function as a knowledge graph (KG) encoder to convert sub-graphs into vectorized representations. These vectorized encodings are subsequently processed through a pipeline of Transformer-based language models, which transform the encodings into natural language (NL) statements. Alternatively, a custom template-based schema may be leveraged or created to facilitate the conversion of sub-graphs into natural language statements.

Further, the sub graph sampling module 324 transforms the encoded vectorized representations into Natural Language (NL) statements based on the validation. After validating the vectorized representations for fluency and syntactic correctness, the module utilizes the approved representations to generate coherent NL statements. These statements are intended to convey the relationships and tasks represented by the sub-graphs in a human-readable form, ensuring that the transformed data is not only accurate but also meaningful and accessible for users. The validation process ensures that only high-quality NL statements are generated, aligning the output with the desired linguistic and contextual standards.

FIG. 3C illustrates the process of creating code snippets, in accordance with an embodiment of the present disclosure. As shown, the sub-graph sampling module 324 creates sub-graphs from the knowledge graph. Then the module 324 converts the sub-graphs into natural language text using one of the template-based methods or using the graph neural networks. For example, the sub-graph “Ekart—(Controller and WebUI)” is converted into natural language text “Ekart project includes Controller and WebUI functionality package”. Then the module 324 generates code snippets for each natural language texts using the LLM.

The probabilistic module 326 generates and evaluates probabilistic relationships within the knowledge graph, based on the connections between tasks and associated components. It assesses the likelihood of different paths or actions within the software project's development lifecycle, offering insights into potential future states or risks. The probabilistic module 326 may utilize various probabilistic techniques, such as Bayesian networks or Markov models, to calculate the probability distributions of different outcomes. These probabilities may inform decision-making processes by highlighting the most likely scenarios or identifying uncertain areas that may require further investigation or mitigation strategies. Through its function, the probabilistic module 326 enhances the system 114's ability to predict and manage dynamic conditions and dependencies within the software project.

The probabilistic module 326 computes a vulnerability score for the plurality of prompts based on vulnerability, severity and a probability of vulnerability occurring. The probabilistic module 326 evaluates the probability of each vulnerability occurring based on observed patterns and templates derived from past data. This computation integrates factors such as historical trends, contextual relevance of vulnerabilities, and the criticality of their impact, enabling a nuanced understanding of risk across various software development contexts.

The vulnerability score is mapped to the plurality of nodes in the sub-graphs. This mapping allows for a granular view of risk distribution across the sub-graphs, enabling targeted analysis and intervention. By associating vulnerability scores with nodes, the system facilitates the identification of high-risk areas and supports informed decision-making for enhancing software security.

To compute the vulnerability score, the probabilistic module 326 detects vulnerabilities in the plurality of prompts using a vulnerability detection method. The vulnerability detection method identifies patterns, anomalies, or known vulnerabilities by referencing pre-defined databases of vulnerable templates, historical data, and machine learning models trained to recognize potential security issues. The probabilistic module 326 leverages both syntactic and semantic insights from the prompts to ensure accurate identification of security risks.

Vulnerabilities are detected in the code snippets generated from NL statements. The probabilistic module 326 evaluates these code snippets to identify security weaknesses, such as improper access controls, weak encryption protocols, or outdated dependencies. By applying both static and dynamic analysis, the probabilistic module 326 ensures comprehensive vulnerability detection tailored to the generated code.

Further, the probabilistic module 326 maps the detected vulnerabilities to each of the plurality of nodes within the sub-graphs. This mapping establishes a link between specific vulnerabilities and the tasks or components represented by the nodes. By associating vulnerabilities with individual nodes, the probabilistic module 326 provides a detailed understanding of the risk distribution across the sub-graphs.

Each vulnerability is associated with a severity score and a frequency score. The severity score quantifies the potential impact of the vulnerability, considering factors such as criticality and the extent of potential damage. The frequency score represents how often the vulnerability has been identified in historical software projects or similar contexts, adding a temporal dimension to the risk assessment.

Thereafter, the probabilistic module 326 computes the vulnerability score for each node in the sub-graph. The computed vulnerability score incorporates the severity score, and the frequency score associated with the node. By integrating these dimensions, the probabilistic module 326 produces a numerical representation of the security risk for each node, supporting prioritization in addressing vulnerabilities.

The vulnerability score is a heuristic function of the severity score and the frequency score, and wherein the heuristic function corresponds to one of a polynomial and non-polynomial function normalized by a total count of relevant plurality of prompts. This normalization ensures that the vulnerability scores are proportionally distributed and reflect the relative risk levels across the sub-graphs. By using such heuristic computations, the probabilistic module 326 enables flexibility in modeling varying risk scenarios while maintaining accuracy and efficiency.

The clustering module 328 extracts probabilistic vulnerable templates corresponding to the plurality of prompts based on the computed vulnerability score. The probabilistic module identifies patterns in the vulnerabilities based on previously computed scores, highlighting the most vulnerable aspects of the generated prompts. These templates are then extracted and analyzed, providing a basis for further refinement and prioritization of remediation strategies.

The clustering module 328 extracts a set of prompts from among the plurality of prompts indicated as vulnerable based on previously computed vulnerability scores. The clustering module 328 identifies and selects the prompts that have been classified as vulnerable based on the severity and frequency of the associated vulnerabilities. These selected prompts become the focus of clustering efforts, allowing for targeted analysis of potential security risks.

Further, the clustering module 328 generates a tree data structure for each of the extracted set of prompts. The tree data structure represents the hierarchical organization of the prompt elements, facilitating an analysis of the relationships and dependencies among the identified vulnerable components. This structure aids in visualizing how different elements within the prompts contribute to the overall vulnerability profile.

The generated tree structure corresponds to a dependency parse tree, extracted from a neural network-based models. The dependency parse tree represents the grammatical relationships and syntactic dependencies between the components of each prompt. Neural network-based models are used to extract these structures, leveraging their ability to capture nuanced relationships between elements in natural language inputs, thereby enhancing the accuracy of vulnerability detection.

The clustering module 328 clusters the generated data structure to create clusters based on semantic similarity, and probabilistic vulnerabilities associated with the prompts. The clustering process groups prompts that share common semantic meanings, dependencies, and vulnerability patterns. This clustering facilitates a more focused analysis of vulnerabilities that share similar characteristics, improving the efficiency of remediation efforts.

Further, the clustering module 328 generates a high-level structure for each cluster of prompts. This high-level structure provides an overview of the vulnerabilities associated with each cluster, summarizing the critical elements that define the overall risk profile. It enables the system 114 to assess the broader impact of vulnerabilities within the software project and aids in prioritizing the addressing of the most critical vulnerabilities.

The high-level structure is used during run-time for vulnerability detection. At run-time, the high-level structure serves as a reference for the system to quickly identify and address new instances of vulnerabilities that may arise in the course of the software development lifecycle. It ensures that vulnerability detection remains efficient, context-aware, and aligned with latest analyses.

Furthermore, the clustering module 328transforms each prompt into a representation for clustering by extracting syntactic structures using dependency parse trees and generating semantic representations as vectorized embeddings using transformer-based neural network models. By combining syntactic and semantic representations, the clustering module 328 ensures that the prompts are understood both at a structural and contextual level. This dual-level representation captures the complexity of language, leading to more accurate clustering results.

The clustering module 328 merges the syntactic representation and semantic representations of the prompts, along with the associated vulnerability scores, into an n-dimensional matrix. The merging process consolidates the various dimensions of the prompt data, including syntactic structure, semantic meaning, and vulnerability risk, into a unified matrix. This matrix enables more efficient processing and comparison of prompts during the clustering phase.

The n-dimensionality matrix is determined by an axis of representation. The axes of the matrix represent different aspects of the prompt data, such as syntactic elements, semantic features, and vulnerability severity. By organizing the matrix along these axes, the clustering module 328 is able to identify the most relevant features and relationships that define the vulnerabilities.

Further, the clustering module 328 identifies the closest matching template by aligning the merged syntactic representation and semantic representations with the n-dimensional matrix. This alignment process enables the system 114 to match prompts with known vulnerability templates that have similar characteristics, improving the accuracy and efficiency of vulnerability detection and remediation.

Thereafter, the clustering module 328 maps the identified closest matching template to a corresponding sub-graph of the knowledge graph (KG). The sub-graph corresponds to components associated with the vulnerability template. The sub-graph mapping links the identified vulnerability to the relevant components in the knowledge graph, enabling the system 114 to locate and address vulnerabilities within the context of the overall software project. This mapping enhances the effectiveness of vulnerability detection and resolution by placing vulnerabilities within the broader framework of the software supply chain.

FIG. 3D illustrates the process of generating vulnerable clusters, in accordance with an embodiment of the present disclosure. As shown, the probabilistic module 326 receives code snippets associated with the prompts, detects the vulnerabilities associated with each prompt and stores the vulnerability list in a database. Further, the probabilistic module 326 computes a vulnerability score as shown and stores the vulnerable prompt list and the scores for further processing. As described, in one embodiment, the set of prompts which have been marked as vulnerable are used for extracting probabilistic vulnerable templates. The template structure of the prompts may be abstracted out as a tree data structure (e.g. AST) and may be used to cluster the abstraction based on semantic similarity, tree structure and the probabilistic vulnerabilities. A high-level structure may emerge out of each cluster, which will used during run-time. Referring to FIG. 3D, the clustering module 326 creates one or more clusters of vulnerable based on the appended features of the vulnerable prompt list as shown.

In one embodiment, the vulnerability module 308 is communicably coupled to an assessment module 310. In this regard, components of the assessment module 310 may access and utilize the resources of the vulnerability module 308 since their components may communicate with each other. The assessment module 310 refers to a component within the system 114 that evaluates the quality and relevance of the generated prompts, sub-graphs, and their corresponding vulnerabilities. The assessment module 310 utilizes analysis of various performance metrics, including accuracy, completeness, and vulnerability severity, for real-time evaluation of natural language-abstracted data artifacts from various stages of the software development life cycle. Further, the assessment module 310 may also implement soft binding of alternate secure components to vulnerable prompts for realizing implementations of the present disclosure.

The assessment module 310 comprises a pipeline generator 330, a search module 332, a probabilistic module 334, and a code snippet generation module 336. The pipeline generator 330 is a component which automatically constructs processing pipelines for data handling and task execution. It generates workflows that connect different components of the system based on predefined rules and contextual requirements.

The pipeline generator 330 creates a customized priority pipeline for the extracted probabilistic vulnerable templates. Specifically, the pipeline generator 330 creates the customized priority pipeline by organizing the sequence of tasks, actions, and components that address each identified vulnerability. The pipeline generator 330 evaluates the criticality of vulnerabilities and the dependencies between various components to determine the most effective sequence for mitigating risks. This prioritization ensures that the most pressing vulnerabilities are addressed first, enhancing the overall security and efficiency of the software development process.

The customized priority pipeline comprises a plurality of alternate components. Here, each component represents a potential solution or action to address a specific vulnerability. These components may include various remediation techniques, secure coding practices, or security patches that can be applied depending on the context of the vulnerability. The alternate components provide flexibility in addressing vulnerabilities, allowing the pipeline to adapt to different development environments, tools, and requirements while maintaining an optimal flow for mitigating identified risks.

The probabilistic module 334 refers to a component that applies probabilistic models to assess the likelihood of certain vulnerabilities or risks occurring within the software project. By analyzing historical data, task characteristics, and component attributes, the probabilistic module 334 calculates vulnerability scores and predicts the probability of vulnerabilities impacting the project. This enables the system 114 to prioritize and address the vulnerabilities with the highest likelihood and potential impact, ensuring a more effective risk management process.

The probabilistic module 334 selects at least one vulnerable template with a highest vulnerability score based on probabilistic functions. The probabilistic module 334 selects the vulnerable template by evaluating a range of factors, such as the severity, frequency, and potential impact of vulnerabilities. This selection process utilizes predefined functions that consider historical data and vulnerability patterns to prioritize the most critical templates for further action. The highest vulnerability score indicates the vulnerability templates most likely to have a significant impact on the software, ensuring that resources are focused on addressing the most pressing issues.

The highest vulnerability score indicates highest level of detected vulnerabilities, reflecting the likelihood and severity of the vulnerability occurring within the software program. By assigning these scores to the probabilistic vulnerable templates, the system 114 enables efficient decision-making, prioritizing templates that present the greatest risk. This approach ensures that remediation efforts are focused on the areas with the most critical vulnerabilities, reducing the overall exposure to potential security threats.

To enable varied cluster structures, the sub-graphs being sampled may be sourced from different stages of the Software Development Life Cycle (SDLC). Further, the sampling distance may be maximized to ensure the capture of a diverse range of template structures.

The probabilistic module 334 maps the received input data with the extracted probabilistic vulnerable templates using a semantic similarity matching. By comparing the input data, such as newly identified vulnerabilities or tasks, with the extracted templates, the probabilistic module 334 determines the closest matches between current and past vulnerability scenarios. This mapping process allows the system to identify relevant templates and understand the potential vulnerabilities associated with the input data in the context of previous experiences.

In this regard, the semantic similarity matching comprises calculating pairwise semantic similarity scores between the received input and the plurality of nodes of the knowledge graph using a similarity method. The similarity method compares the semantic content of the input data with nodes in the knowledge graph, which represent different software tasks, components, or vulnerabilities. The higher the similarity score, the more closely related the input data is to a specific node, which helps the system 114 identify the most relevant templates for the given situation.

Further, the matching comprises selecting the highest ranked node based on the pairwise semantic similarity scores and business rules. Once the pairwise similarity scores are calculated, the system 114 ranks the nodes to identify the most relevant and critical matches. Business rules, such as task criticality or security policies, are then applied to ensure that the highest-ranked node is the one that aligns with the software project's goals and security requirements. This selection process ensures that the vulnerability detection and mitigation efforts are both contextually relevant and aligned with organizational needs.

Based on the mapping between the extracted probabilistic vulnerable template and a secure component in a knowledge base, an alternate secure component is selected. Upon identifying the most relevant probabilistic vulnerable template, the system 114 cross-references it with a knowledge base of secure components, which contain components or solutions that can mitigate or address the detected vulnerabilities. If a secure component is found, it is used as an alternative to mitigate the risk posed by the vulnerable template, ensuring that the software system can continue to function securely and efficiently.

The knowledge base refers to a centralized repository 338 associated with the system 114. The probabilistic module 334 works in tandem with the search module 332 to access the secure component from the centralized repository 338. The search module 332 is a component responsible for retrieving relevant data, patterns, or vulnerabilities from data sources. The search module 332 employs advanced querying techniques to find information based on specific parameters, such as task criticality, component relevance, or vulnerability occurrence. By using optimized search algorithms, the search module 332 ensures that only relevant and high-priority data is retrieved for further analysis or processing.

The probabilistic module 334 determines if the vulnerability score exceeds a predefined risk level based on the selected alternate secure component. The probabilistic module 334 determines if the vulnerability score exceeds the predefined risk level by comparing the computed vulnerability score against a threshold value established for acceptable risk. The predefined risk level represents the maximum tolerable vulnerability severity and frequency for the software project. If the score surpasses this threshold, it signals a critical risk that requires immediate attention, prompting the integration of the alternate secure component to mitigate potential threats effectively.

The highest vulnerability score is determined by aggregating vulnerability metrics across the sub-graphs, along with the relationships between the plurality of nodes. This aggregation involves analyzing individual node vulnerabilities, their connections to other nodes, and the overall structure of the sub-graphs. By considering metrics such as severity, frequency, and dependency relationships, the probabilistic module 334 computes a comprehensive score reflecting the overall vulnerability risk within the sub-graphs. This holistic approach ensures that the most critical vulnerabilities are accurately identified and prioritized.

Thereafter, the probabilistic module 334 dynamically updates the knowledge base and a Software Development Life Cycle (SDLC) with the selected alternate secure component based on the determination. Upon identifying a secure component to address the detected vulnerabilities, the system integrates it into the knowledge base to enrich future reference data. Simultaneously, the SDLC is updated to include the secure component in relevant stages, ensuring that subsequent software development processes proactively incorporate the identified security measures. This dynamic update mechanism facilitates continuous improvement of the system's security posture.

The code snippet generation module 336 generates code snippets that correspond to the Natural Language (NL) prompts and vulnerabilities identified within the software project. These code snippets are generated based on the analysis of the sub-graphs, vulnerabilities, and detected patterns, providing developers with actionable and contextually appropriate code examples. The code snippet generation module 336 assists in automatically generating code that helps in mitigating or addressing the identified vulnerabilities, improving the efficiency and accuracy of the development process. In an embodiment, the code snippet generation module 336 enables code generation by passing transformed prompt to a Code-LLM. It is to be noted that the code generation is an example use case of the proposed solution, and the system is configured for identifying vulnerabilities and mitigating the same during the entire software development life cycle, for example from planning till execution.

The code snippet generation module 336 generates code snippets for the received input data based on the selected at least one vulnerable template. The code snippet generation module 336 generates code snippets by analyzing structural and functional attributes of the identified template. This analysis involves synthesizing secure coding patterns that replace or mitigate the vulnerabilities present in the template. By aligning the generated code snippets with the specific requirements of the input data, the code snippet generation module 336 ensures that the resulting code is tailored to address the identified vulnerabilities while maintaining the intended functionality.

The code snippets correspond to zero vulnerabilities and wherein the code snippets comprise the alternate components for the received input data. The module integrates alternate components, identified as secure replacements for vulnerable ones, into the generated code snippets. These alternate components are selected to ensure that the generated code adheres to security best practices, eliminating detected vulnerabilities. As a result, the produced code snippets provide a robust solution to the input data's requirements while upholding high-security standards.

For generating the code snippets, the code snippet generation module 336 retrieves a high-level node corresponding to the received input data using the probabilistic function. The high-level node serves as an anchor point in the knowledge graph, representing a critical task, component, or relationship that closely aligns with the properties of the received input data. The probabilistic function determines this alignment by evaluating factors such as relevance to historical patterns, frequency of use in similar tasks, and the likelihood of addressing the current input effectively.

In some implementations, the probabilistic function may be implemented as a soft binding function. The soft binding function refers to a function which establishes relationships or associations between components or elements with flexibility, allowing for some degree of looseness or adaptability. Unlike strict binding functions, which enforce rigid, fixed relationships, soft binding enables dynamic associations that can evolve or adjust based on context or additional input.

In the context of the present disclosure, the soft binding function may establish connections between variables, components, or datasets that are not permanent but rather adaptable, typically guided by probabilistic or heuristic models. This flexibility allows the system to maintain functional integrity while accommodating changes in data or requirements over time. For example, in a software development lifecycle (SDLC), the soft binding function may be used to link different tasks, libraries, or software modules in a way that allows them to be reconfigured as the project evolves, ensuring compatibility without enforcing strict dependencies.

The code snippet generation module 336 iteratively updates subsequent nodes to form an updated sub-graph. Subsequent nodes, which represent additional tasks or components linked to the high-level node, are incorporated into the sub-graph through multiple iterations. Each iteration examines connections in the knowledge graph and includes nodes that contribute to a more complete and contextually accurate representation of the input data.

The subsequent nodes are determined based on a semantic relevance to the high-level node. Semantic relevance is assessed by comparing attributes such as node content, relationships, and historical context in the knowledge graph. Nodes that exhibit strong linguistic, functional, or conceptual ties to the high-level node are prioritized for inclusion in the sub-graph.

Further, the code snippet generation module 336 recursively computes semantic scores between the updated sub-graph and the received input data. Semantic scores reflect the degree of similarity or alignment between the characteristics of the evolving sub-graph and the requirements of the input data. This computation is performed at each iteration to evaluate how well the sub-graph captures the input's intent.

The recursive computation continues until a constant semantic score in the semantic scores is detected. When the semantic score stabilizes, it indicates that the sub-graph has reached an optimal state, fully representing the input data without further refinement. This ensures efficiency by terminating unnecessary iterations.

The code snippet generation module 336 extracts largest relevant sub-graph based on the constant semantic score. The extracted sub-graph includes all nodes and relationships determined to be crucial for addressing the input data. By focusing on relevance, the extracted sub-graph balances comprehensiveness with precision, discarding less pertinent elements.

The largest relevant sub-graph comprises the plurality of levels of tasks, and the associated components. This sub-graph captures the hierarchical structure of the tasks, along with the dependencies and functional elements necessary for generating accurate and effective code snippets.

Further, the code snippet generation module 336 computes a template risk score as a weighted function of at least one of the vulnerability scores associated with nodes, the frequency of occurrence of the template in historical projects, the probability of vulnerability occurrence and the severity score of a business domain. The template risk score quantifies the potential risk associated with using a specific template by combining multiple metrics. This score helps prioritize templates that minimize vulnerabilities while considering domain-specific requirements and historical patterns.

Furthermore, the code snippet generation module 336 ranks the plurality of alternate components using a ranking function based on the computed template risk score. The ranking function assigns priority to alternate components by evaluating their relative risk and utility. Components with lower risk and higher suitability for the input data are ranked higher to ensure secure and efficient code generation.

Thereafter, the code snippet generation module 336 generates the code snippets for the received input data based on the ranked plurality of alternate components. Using the ranked components, the code snippets are created to meet the input data's requirements while adhering to security and functionality standards. This step synthesizes components into a coherent snippet.

The generated code snippets comprise the ranked plurality of alternate components. These snippets incorporate the most relevant and secure components, providing a comprehensive solution tailored to the input data while minimizing vulnerabilities and ensuring operational reliability.

The code snippet generation module 336 shares the generated code snippets with a recommendation module 304. The recommendation module 304 and the assessment module 310 are communicably coupled.

The recommendation module 304 refers to a system component that provides a suggested list of Software Bill of Materials (SBOMs) tailored to align with the requirements of the received input data. The recommendation module 304 evaluates the input data against predefined criteria, leveraging historical data and context-specific attributes to identify the most suitable SBOMs. By generating recommendations that incorporate task-specific dependencies and component-level relationships, the recommendation module 304 ensures a comprehensive alignment between the suggested SBOMs and the operational requirements of the input data. Hence, the proposed system secures the SBOMs by securing the software supply chain.

The recommendation module comprises middleware 312 and a stage specific recommendation adapter 314. Middleware 312 refers to an intermediary software layer within the recommendation module 304 that facilitates seamless communication and data exchange between the various components of the system. Middleware 312 processes input data by integrating it with the knowledge base 204 and other system modules, ensuring compatibility and consistency in data flow. This integration enables efficient analysis and retrieval of relevant information required for generating the recommended SBOMs.

The stage-specific recommendation adapter 314 refers to a specialized component within the recommendation module 304 that tailors the SBOM recommendations to specific stages of the Software Development Life Cycle (SDLC). The stage-specific recommendation adapter 314 dynamically adjusts the suggested SBOMs based on the requirements, constraints, and characteristics of the SDLC stage under consideration. By aligning the recommendations with stage-specific priorities, the stage-specific recommendation adapter 314 ensures that the SBOMs are both contextually appropriate and actionable.

Specifically, the code snippet generation module 336 shares the generated code snippets with the stage specific recommendation adapter 314. This facilitates passing the code snippets optimized for addressing detected vulnerabilities or enhancing functionalities to the recommendation adapter for further refinement and adaptation. For instance, when the generated snippet relates to resolving dependency vulnerabilities in the software program, the stage-specific recommendation adapter processes it to align with the development stage requirements.

The stage specific recommendation adapter 314 output the generated code snippets to a software development environment. The software development environment refers to the tools, frameworks, and configurations where the software project is actively built, tested, and maintained. This environment could include Integrated Development Environments (IDEs), for example, Eclipse, Visual Studio, or PyCharm, as well as Continuous Integration/Continuous Deployment (CI/CD) pipelines. For example, the adapter may format the code snippet as a script ready for testing in a CI tool like Jenkins or as code integrated directly into an IDE for real-time testing.

Further, the recommendation module 304 maps the generated code snippets with a plurality of Software Bill of Materials (SBOM) formats. This mapping ensures that the code snippets are documented alongside their dependencies, vulnerabilities, and related metadata in a structured format, promoting traceability and compliance. For example, a snippet that resolves a security vulnerability in a library would be documented in JSON to capture detailed attributes such as the resolved vulnerability's CVE identifier and the updated library version.

The plurality of SBOM formats comprise one of an XML, a JSON, and a YAML format. Each of these formats has unique advantages: XML ensures strict schema validation, JSON supports lightweight and efficient data transmission, and YAML provides a human-readable structure for easier review. For instance, YAML could be used for a configuration-heavy SBOM containing a patched container image's dependencies and associated scripts for deployment.

As described, the code generation is an example use case of the proposed solution, and the system is configured for identifying vulnerabilities and mitigating the same during the entire software development life cycle. For instance, during the design phase, the recommendation module 304 suggests alternatives related to secure library selection, whereas in the testing phase, the module recommends alternatives that include unit tests for critical functions. These recommendations are dynamically generated by evaluating the SDLC stage-specific requirements, ensuring that the suggestions align with the project's progress.

Thereafter, the recommendation module 304 dynamically generates SBOM updates, i.e., output 340 comprising updated secure code snippets based on the generated recommendations. These updates reflect changes in the dependencies and components of the software project, incorporating the newly recommended secure code snippets. For example, if a vulnerable library was replaced with a secure alternative, the updated SBOM would detail this replacement, the associated snippet, and metadata like the resolved vulnerabilities and associated CVE identifiers.

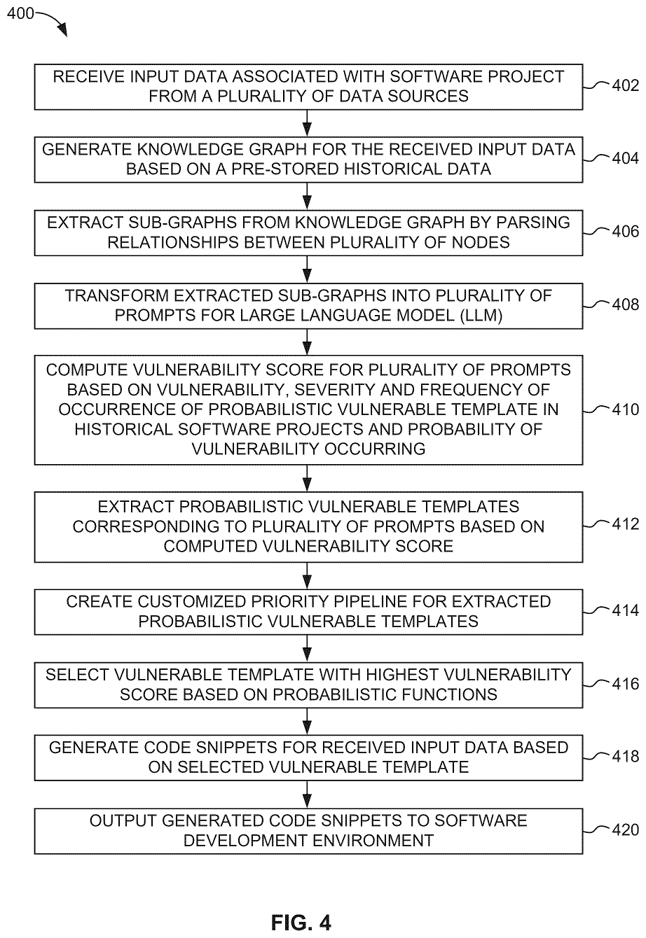

FIG. 4 is a flow diagram presenting an exemplary method 400 in accordance with implementations of the present disclosure.

At step 402, input data associated with a software project is received from a plurality of data sources. The input data comprises a plurality of levels of tasks associated with the software project. These levels may include tasks that are broad and high-level, such as project milestones or phase goals, and more specific, granular tasks, such as individual software functionalities or coding requirements. The different levels of tasks reflect the complexity of the project and capture both overarching goals and detailed actionable items. In an example, the data may be aggregated from GitHub repositories, JIRA project boards, or enterprise software platforms, where tasks at various levels of abstraction (e.g., “design architecture” vs. “write function X”) are tracked. By receiving comprehensive project data from diverse sources, the system ensures a robust foundation for analyzing and securing the software development lifecycle.

At step 404, a knowledge graph is generated for the received input data based on pre-stored historical data. The knowledge graph comprises a plurality of nodes that represent the plurality of levels of tasks and associated components. The nodes capture the relationships between tasks, which can be organized at multiple levels, reflecting the interdependencies across the project's different stages. The associated components refer to elements like software packages, libraries, tools, or frameworks that are linked to the tasks and can include at least one of software packages and libraries, which are crucial for executing tasks or achieving objectives. In an example, the nodes in the knowledge graph might represent tasks like “define system architecture” or “implement login functionality,” and components such as “React.js” or “Spring Boot” may be associated with them, indicating the technology stack required for these tasks. By structuring the input data into a knowledge graph, the system enables better understanding of task relationships and dependencies, facilitating efficient task management and vulnerability analysis.

At step 406, sub-graphs are extracted from the knowledge graph by parsing the relationships between the plurality of nodes. These sub-graphs represent clusters of tasks and their associated components. The extraction focuses on identifying cohesive task groups, which may be related based on functionality, software dependencies, or development stages. The sub-graphs help in grouping tasks together that form a cohesive unit, which can be analyzed or modified independently from other tasks. In an example, a sub-graph might represent tasks related to “user authentication” and include nodes for tasks like “implement login form,” “authenticate user,” and “check user credentials,” with components like “OAuth” or “JWT” linked to these tasks. By extracting relevant sub-graphs, the system reduces complexity and focuses attention on smaller, more manageable groups of tasks, enabling precise analysis and intervention where vulnerabilities might arise.

At step 408, the extracted sub-graphs are transformed into a plurality of prompts for a Large Language Model (LLM). These prompts are converted into natural language statements that are compatible with the LLM's capabilities. The transformation process ensures that the LLM can process the information by representing it as a natural language query or analysis prompt, allowing the model to generate insights, suggestions, or potential risks associated with the tasks or components in the sub-graph. For example, the sub-graph on “user authentication” might be transformed into a prompt such as “Implement authentication for User based on Oauth method and xyz encryption” By transforming technical data into natural language prompts, the system enables the LLM to analyze and provide insights on the project, improving the overall vulnerability detection process.

At step 410, a vulnerability score is computed for the plurality of prompts based on several factors, including the vulnerability type, its severity, frequency of occurrence in historical software projects, and the likelihood of the vulnerability occurring in the current project. The vulnerability score represents an assessment of how critical each identified issue might be, allowing the system to prioritize tasks and components that are most at risk. In an example, the vulnerability score for the “OAuth” prompt might be computed based on historical occurrences of vulnerabilities in OAuth implementations, their severity, and the likelihood of encountering similar issues in the current project. By computing vulnerability scores for the identified tasks and components, the system provides a clear indication of where vulnerabilities are most likely to occur, enabling focused mitigation efforts.

At step 412, probabilistic vulnerable templates corresponding to the plurality of prompts are extracted based on the computed vulnerability score. These templates represent common patterns of vulnerabilities that have been observed in historical projects. The extraction ensures that only the most relevant and likely vulnerabilities are considered, based on the vulnerability score, which acts as a filter for identifying the most critical threats to the project. For example, if the vulnerability score for “OAuth authentication” is high, the system might extract a template corresponding to known security weaknesses in OAuth flows, such as improper token validation or insufficient access controls. By focusing on the most relevant probabilistic vulnerable templates, the system ensures that the generated solutions are based on actual, high-risk vulnerabilities, reducing false positives and irrelevant vulnerabilities.

At step 414, a customized priority pipeline is created for the extracted probabilistic vulnerable templates. This pipeline contains a plurality of alternate components that could replace or mitigate the identified vulnerabilities. For each vulnerable template, alternate components are suggested, which can include different versions of libraries, safer configurations, or more secure coding practices. In an example, the pipeline might suggest using “JWT” instead of “OAuth 2.0” if the OAuth vulnerability score is high and “JWT” is known to have fewer vulnerabilities in the specific context of the software project. By creating a customized pipeline for vulnerable templates, the system ensures that vulnerabilities are addressed with practical, actionable alternatives that improve the security of the software project.

At step 416, at least one vulnerable template with the highest vulnerability score is selected based on probabilistic functions. That is, during runtime when a new input is received, the input is transformed appropriately and then matched to one the probabilistic vulnerable templates with highest score. The highest vulnerability score indicates the most critical vulnerabilities that need to be addressed first. This step prioritizes the vulnerabilities that are most likely to have significant impact on the project, based on historical data and the analysis performed. For example, if a vulnerability related to user authentication has a higher score than other vulnerabilities, it would be selected for remediation first. By selecting the most critical vulnerabilities, the system ensures that the highest priority issues are dealt with first, reducing the overall risk in the project.

At step 418, code snippets are generated for the received input data based on the selected vulnerable template. These code snippets are designed to address the vulnerabilities identified in the selected template and incorporate the alternate components from the customized priority pipeline. The code snippets are tailored to the specific task at hand and are created to eliminate the vulnerabilities while maintaining the functionality of the software project. It is to be noted that the r recommendations are generated which can then be transformed into code snippets based on the SDLC lifecycle phase the input corresponds to. In an example, if a vulnerability in authentication is detected, the system might generate a secure code snippet that replaces insecure authentication methods with safer alternatives, such as using encryption or two-factor authentication. By generating code snippets that are customized for the project's needs, the system ensures that vulnerabilities are directly addressed in the code, improving the security posture of the software.

At step 420, the generated code snippets are output to a software development environment. This ensures that the code snippets can be integrated into the software project, helping developers quickly implement secure solutions without needing to manually address each identified vulnerability. By outputting the generated code snippets to the software development environment, the system facilitates the smooth integration of secure code, reducing the workload on developers and accelerating the remediation process.

Advantageously, the present technology streamlines software development by effectively analyzing and securing complex software projects through the aggregation of diverse task data and historical insights. By utilizing a knowledge graph to map out the relationships between tasks and components, the system ensures that critical vulnerabilities are identified and prioritized efficiently. The use of sub-graphs and customized vulnerability scoring enhances the accuracy of risk assessments, enabling the system to pinpoint high-priority areas in real time, thereby improving overall software security and reducing potential risks.

The described approach addresses the challenges typically faced in traditional vulnerability detection methods by integrating a predictive analysis framework. By leveraging Large Language Models (LLMs) and probabilistic vulnerability templates, the system not only detects but also generates tailored, zero-vulnerability code snippets and/or recommendations. This proactive strategy ensures that developers can address vulnerabilities before they impact the project, enhancing the quality and security of the software. Furthermore, the ability to adapt to varying software project requirements through dynamic task clustering and alternate component generation ensures that the system remains flexible and scalable, optimizing development workflows and supporting continuous improvement in software development practices.

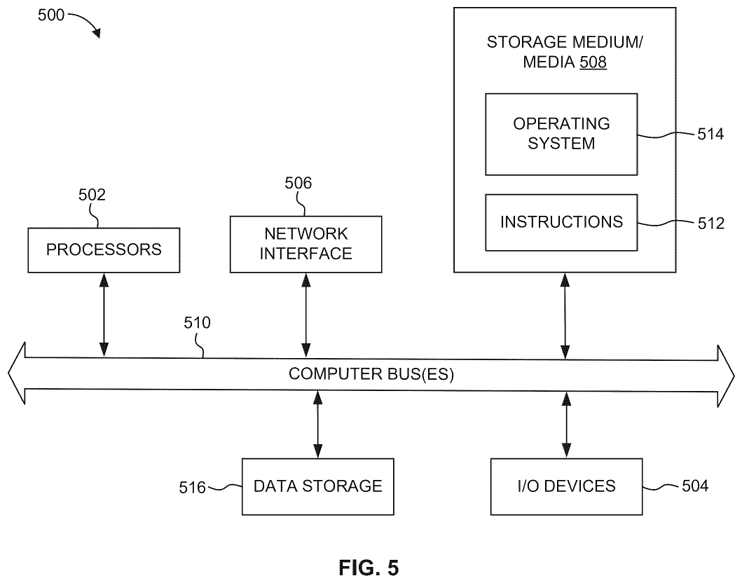

FIG. 5 illustrates a computer system 500 that may be used to implement the system 114. More particularly, computing machines such as desktops, laptops, smartphones, tablets, and wearables which may be used to process the conversational interactions in the system 114 may have the structure of the computer system 500. The computer system 500 may include additional components not shown and that some of the process components described may be removed and/or modified. In another example, a computer system 500 may be deployed on external-cloud platforms such as cloud, internal corporate cloud computing clusters, organizational computing resources, and/or the like.

The computer system 500 includes processor(s) 502, such as a central processing unit, ASIC or another type of processing circuit, input/output devices 504, such as a display, mouse keyboard, etc., a network interface 506, such as a Local Area Network (LAN), a wireless 902.11x LAN, a 3G or 4G mobile WAN or a WiMax WAN, and a processor-readable medium 508. Each of these components may be operatively coupled to a bus 510.

The computer-readable medium 508 may be any suitable medium that participates in providing instructions to the processor(s) 502 for execution. For example, the computer-readable medium 508 may be non-transitory or non-volatile medium, such as a magnetic disk or solid-state non-volatile memory or volatile medium such as RAM. The instructions or modules stored on the computer-readable medium 508 may include machine-readable instructions 512 executed by the processor(s) 502 that cause the processor(s) 502 to perform the methods and functions of the system 114.

The system 114 may be implemented as software stored on a non-transitory processor-readable medium and executed by the processors 502. For example, the computer-readable medium 508 may store an operating system 514, such as MAC OS, MS WINDOWS, UNIX, or LINUX, and code for the system 114. The operating system 514 may be multi-user, multiprocessing, multitasking, multithreading, real-time, and the like. For example, during runtime, the operating system 514 is running and the code for the system 114 is executed by the processor(s) 502.

The computer system 500 may include a data storage 516, which may include non-volatile data storage. The data storage 516 stores any data used or generated by the system 114. The network interface 506 connects the computer system 500 to internal systems for example, via a LAN. Also, the network interface 506 may connect the computer system 500 to the Internet. For example, the computer system 500 may connect to web browsers and other external applications and systems via the network interface 506.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations of the present disclosure provide significant technical advancements in securing AI-assisted software development supply chains. By leveraging dynamic, real-time analysis of software supply chain components, the system efficiently identifies and mitigates vulnerabilities that traditional methods often overlook. The ability to adapt to evolving threats and software configurations ensures that vulnerabilities are detected and addressed proactively, reducing the risk of security breaches. As a result, organizations benefit from enhanced software security, reduced exposure to risks, and improved confidence in their development processes, leading to stronger protection of intellectual property and operational integrity.

Additionally, the system improves vulnerability detection by offering context-specific remediation recommendations tailored to the software development lifecycle. By dynamically generating secure code snippets and updates to the Software Bill of Materials (SBOM) based on real-time analysis, the system reduces the need for exhaustive data collection and processing, minimizing computational costs. This adaptability to evolving project needs and continuous integration pipelines enables organizations to address vulnerabilities promptly and accurately, ensuring consistent software integrity throughout the development lifecycle. Consequently, the system reduces manual intervention, improves overall efficiency, and provides more effective vulnerability management, driving significant cost and time savings while enhancing the security of AI-assisted software projects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them.

The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system 914, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system.

A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks).

However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media, and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination.

Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive an input data associated with a software project from a plurality of data sources, wherein the input data comprises a plurality of levels of tasks associated with the software project;
generate a knowledge graph for the received input data based on pre-stored historical data, wherein the knowledge graph comprises a plurality of nodes representing the plurality of levels of tasks, and associated components, and the associated components comprise at least one of software packages and libraries;
extract sub-graphs from the knowledge graph by parsing relationships between the plurality of nodes, wherein the sub-graphs represent a plurality of clusters of tasks and the associated components;
transform the extracted sub-graphs into a plurality of prompts for a Large Language Model (LLM), wherein the plurality of prompts is transformed into natural language statements;
compute a vulnerability score for the plurality of prompts based on a vulnerability, a severity, and a frequency of occurrence of a probabilistic vulnerable template in historical software projects and a probability of the vulnerability occurring, wherein the vulnerability score is mapped to the plurality of nodes in the sub-graphs;
extract probabilistic vulnerable templates corresponding to the plurality of prompts based on the computed vulnerability score;
create a customized priority pipeline for the extracted probabilistic vulnerable templates, wherein customized priority pipeline comprises a plurality of alternate components;
select at least one vulnerable template with a highest vulnerability score based on probabilistic functions, wherein the highest vulnerability score indicates highest level of detected vulnerabilities;
generate, code snippets or recommendations, for the received input data based on the selected at least one vulnerable template, wherein the code snippets correspond to zero vulnerabilities and wherein the code snippets comprise the alternate components for the received input data; and
output the generated code snippets to a software development environment.

2. The system of claim 1, wherein to select the at least one vulnerable template with the highest vulnerability score based on the probabilistic function, the processor is configured to:
process a historical software project data to extract probabilistic vulnerable templates representing vulnerable task clusters;
map the received input data with the extracted probabilistic vulnerable templates using a semantic similarity matching, wherein the semantic similarity matching comprises:
calculating pairwise semantic similarity scores between the received input and the plurality of nodes of the knowledge graph using a similarity method; and
selecting the highest ranked node based on the pairwise semantic similarity scores and business rules;
select an alternate secure component based on the mapping between the extracted probabilistic vulnerable template and a secure component in a knowledge base;
determine if the vulnerability score exceeds a predefined risk level based on the selected alternate secure component, wherein the highest vulnerability score is determined by aggregating vulnerability metrics across the sub-graphs, along with the relationships between the plurality of nodes; and
dynamically update the knowledge base and a Software Development Life Cycle (SDLC) with the selected alternate secure component based on the determination.

3. The system of claim 1, wherein the processor is configured to:
map the generated code snippets with a plurality of Software Bill of Materials (SBOM) formats, wherein the plurality of SBOM formats comprise one of an XML, a JSON, and a YAML format;
generate recommendations for the generated code snippets based on a stage of a Software Development Life Cycle (SDLC); and
dynamically generate SBOM updates comprising updated secure code snippets based on the generated recommendations.

4. The system of claim 1, wherein to generate the knowledge graph for the received input data based on the pre-stored historical data, the processor is configured to:
extract the plurality of levels of tasks from the pre-stored historical data, wherein the pre-stored historical data comprises internal code repository and a historical Software Bill of Materials (SBOM);
extract descriptions of the associated components of the high-level tasks and the low-level tasks;
create the plurality of nodes representing the plurality of levels of tasks, and the associated components;
generate relationships between the created plurality of nodes by correlating each of the plurality of levels of tasks, and the associated components; and
generate the knowledge graph for the received input data based on generated relationships and the created plurality of nodes.

5. The system of claim 1, wherein to extract the sub-graphs from the knowledge graph by parsing the relationships between the plurality of nodes, the processor is configured to:
identify clusters within the knowledge graph by grouping the plurality of nodes based on a task similarity and a component relevance, wherein each cluster corresponds to a sub-graph and represents the plurality of levels of tasks and the associated components;
prioritize a node relevance, and a component relevance within the identified clusters based on a historical vulnerability data, a task criticality, and a SDLC feature importance;
generate the sub-graphs based on the priority by using probabilistic paths, wherein the probabilistic paths are generated by traversing the knowledge graph based on transition probabilities, wherein the transition probabilities correspond to functions of a current node, previously traversed nodes, and candidate nodes; and
apply a sub-sampling function to the generated sub-graphs from the knowledge graph, wherein the sub-graphs represent clustered tasks and components.

6. The system of claim 5, wherein the processor is configured to:
evaluate the extracted sub-graphs based on a predetermined quality metrics to compute an accuracy score and a completeness score, wherein the completeness score is measured as a function of a number of node types present in each sub-graph relative to the knowledge graph; and
dynamically adjust the predetermined quality metrics and the knowledge graph based on feedback from post-processing of the plurality of prompts, the computed accuracy score, and the completeness score.

7. The system of claim 1, wherein to transform the extracted sub-graphs into the plurality of prompts for a Large Language Model (LLM), the processor is configured to:
encode the extracted sub-graphs into vectorized representations using a pre-trained Graph Neural Networks (GNNs), wherein the vectorized representations are processed using a pipeline of transformer-based language models;
validate the encoded vectorized representations using a Natural Language (NL)-specific metrics, comprising a fluency and a syntactic correctness; and
transform the encoded vectorized representations into Natural Language (NL) statements based on the validation.

8. The system of claim 1, wherein to compute the vulnerability score for the plurality of prompts based on the vulnerability, the severity, and the frequency of occurrence of the probabilistic vulnerable template in the historical software projects and the probability of the vulnerability occurring, the processor is configured to:
detect vulnerabilities in the plurality of prompts using a vulnerability detection method;
map the detected vulnerabilities to each of the plurality of nodes within the sub-graphs, wherein each vulnerability is associated with a severity score and a frequency score; and
compute the vulnerability score for each node in the sub-graph, wherein the vulnerability score is a heuristic function of the severity score and the frequency score, and wherein the heuristic function corresponds to one of a polynomial and non-polynomial function normalized by a total count of relevant plurality of prompts.

9. The system of claim 1, wherein to extract the probabilistic vulnerable templates corresponding to the plurality of prompts based on the computed vulnerability score, the processor is configured to:
extract a set of prompts from among the plurality of prompts indicated as vulnerable based on previously computed vulnerability scores;
generate a tree data structure for each of the extracted set of prompts, wherein the generated tree structure corresponds to a dependency parse tree, extracted from a neural network-based models;
cluster the generated tree data structure to create clusters based on semantic similarity, and probabilistic vulnerabilities associated with the prompts;
generate a high-level structure for each cluster of prompts, wherein the high-level structure is used during run-time for vulnerability detection;
transform each prompt into a representation for clustering by extracting syntactic structures using dependency parse trees and generating semantic representations as vectorized embeddings using transformer-based neural network models;
merge the syntactic representation and semantic representations of the prompts, along with the associated vulnerability scores, into an n-dimensional matrix, wherein the n-dimensionality matrix is determined by an axis of representation;
identify the closest matching template by aligning the merged syntactic representation and semantic representations with the n-dimensional matrix; and
map the identified closest matching template to a corresponding sub-graph of the knowledge graph (KG), wherein the sub-graph corresponds to components associated with the vulnerability template.

10. The system of claim 1, wherein to generate the code snippets for the received input data based on the selected at least one vulnerable template, the processor is configured to:
retrieve a high-level node corresponding to the received input data using the probabilistic function;
iteratively update subsequent nodes to form an updated sub-graph, the subsequent nodes are determined based on a semantic relevance to the high-level node;
recursively compute semantic scores between the updated sub-graph and the received input data, wherein the recursive computation continues until a constant semantic score in the semantic scores is detected;
extract largest relevant sub-graph based on the constant semantic score, wherein the largest relevant sub-graph comprises the high-level tasks, the low-level tasks, and the associated components;
compute a template risk score as a weighted function of at least one of the vulnerability scores associated with nodes, the frequency of occurrence of the template in historical projects, the probability of vulnerability occurrence and the severity score of a business domain;
rank the plurality of alternate components using a ranking function based on the computed template risk score; and
generate the code snippets for the received input data based on the ranked plurality of alternate components, wherein the generated code snippets comprise the ranked plurality of alternate components.

11. A method comprising:
receiving, by a processor, an input data associated with a software project from a plurality of data sources, wherein the input data comprises high-level tasks and low-level tasks associated with the software project;
generating, by the processor, a knowledge graph for the received input data based on a pre-stored historical data, wherein the knowledge graph comprises a plurality of nodes representing the high-level tasks, the low-level tasks, and associated components, and the associated components comprise at least one of software packages and libraries;
extracting, by the processor, sub-graphs from the knowledge graph by parsing relationships between the plurality of nodes, wherein the sub-graphs represent a plurality of clusters of tasks and the associated components;
transforming, by the processor, the extracted sub-graphs into a plurality of prompts for a Large Language Model (LLM), wherein the plurality of prompts are transformed into natural language statements;
computing, by the processor, a vulnerability score for the plurality of prompts based on a vulnerability, a severity, and a frequency of occurrence of a probabilistic vulnerable template in historical software projects and a probability of the vulnerability occurring, wherein the vulnerability score is mapped to the plurality of nodes in the sub-graphs;
extracting, by the processor, probabilistic vulnerable templates corresponding to the plurality of prompts based on the computed vulnerability score;
creating, by the processor, a customized priority pipeline for the extracted probabilistic vulnerable templates, wherein customized priority pipeline comprises a plurality of alternate components;
selecting, by the processor, at least one vulnerable template with a highest vulnerability score based on probabilistic functions, wherein the highest vulnerability score indicates highest level of detected vulnerabilities;
generating, by the processor, code snippets or recommendations for the received input data based on the selected at least one vulnerable template, wherein the code snippets correspond to zero vulnerabilities and wherein the code snippets comprise the alternate components for the received input data; and
outputting, by the processor, the generated code snippets to a software development environment.

12. The method of claim 11, wherein selecting the at least one vulnerable template with the highest vulnerability score based on the probabilistic function comprises:
processing, by the processor, a historical software project data to extract probabilistic vulnerable templates representing vulnerable task clusters;
mapping, by the processor, the received input data with the extracted probabilistic vulnerable templates using a semantic similarity matching, wherein the semantic similarity matching comprises:
calculating, by the processor, pairwise semantic similarity scores between the received input and the plurality of nodes of the knowledge graph using a similarity method; and
selecting, by the processor, the highest ranked node based on the pairwise semantic similarity scores and business rules;
selecting, by the processor, an alternate secure component based on the mapping between the extracted probabilistic vulnerable template and a secure component in a knowledge base;
determining, by the processor, if the vulnerability score exceeds a predefined risk level based on the selected alternate secure component, wherein the highest vulnerability score is determined by aggregating vulnerability metrics across the sub-graphs, along with the relationships between the plurality of nodes; and
dynamically updating, by the processor, the knowledge base, and a Software Development Life Cycle (SDLC) with the selected alternate secure component based on the determination.

13. The method of claim 11, further comprises:
mapping, by the processor, the generated code snippets with a plurality of Software Bill of Materials (SBOM) formats, wherein the plurality of SBOM formats comprise one of an XML, a JSON, and a YAML format;
generating, by the processor, recommendations for the generated code snippets based on a stage of a Software Development Life Cycle (SDLC); and
dynamically generating, by the processor, SBOM updates comprising updated secure code snippets based on the generated recommendations.

14. The method of claim 11, wherein generating the knowledge graph for the received input data based on the pre-stored historical data comprises:
extracting, by the processor, the high-level tasks, and the low-level tasks from the pre-stored historical data, wherein the pre-stored historical data comprises internal code repository and a historical Software Bill of Materials (SBOM);
extracting, by the processor, descriptions of the associated components of the high-level tasks and the low-level tasks;
creating, by the processor, the plurality of nodes representing the high-level tasks, the low-level tasks, and the associated components;
generating, by the processor, relationships between the created plurality of nodes by correlating each of the high-level tasks, the low-level tasks, and the associated components; and
generating, by the processor, the knowledge graph for the received input data based on generated relationships and the created plurality of nodes.

15. The method of claim 11, wherein extracting the sub-graphs from the knowledge graph by parsing the relationships between the plurality of nodes comprises:
identifying, by the processor, clusters within the knowledge graph by grouping the plurality of nodes based on a task similarity and a component relevance, wherein each cluster corresponds to a sub-graph and represents the high-level tasks, the low-level tasks, and the associated components;
prioritizing, by the processor, a node relevance, and a component relevance within the identified clusters based on a historical vulnerability data, a task criticality, and a SDLC feature importance;
generating, by the processor, the sub-graphs based on the priority by using probabilistic paths, wherein the probabilistic paths are generated by traversing the knowledge graph based on transition probabilities, wherein the transition probabilities correspond to functions of a current node, previously traversed nodes, and candidate nodes; and
applying, by the processor, a sub-sampling function to the generated sub-graphs from the knowledge graph, wherein the sub-graphs represent clustered tasks and components.

16. The method of claim 11, wherein transforming the extracted sub-graphs into the plurality of prompts for a Large Language Model (LLM) comprises:
encoding, by the processor, the extracted sub-graphs into vectorized representations using a pre-trained Graph Neural Networks (GNNs), wherein the vectorized representations are processed using a pipeline of transformer-based language models;
validating, by the processor, the encoded vectorized representations using a Natural Language (NL)-specific metrics, comprising a fluency and a syntactic correctness; and
transforming, by the processor, the encoded vectorized representations into Natural Language (NL) statements based on the validation.

17. The method of claim 11, wherein computing the vulnerability score for the plurality of prompts based on the vulnerability, the severity, and the frequency of occurrence of the probabilistic vulnerable template in the historical software projects and the probability of the vulnerability occurring comprises:
detecting, by the processor, vulnerabilities in the plurality of prompts using a vulnerability detection method;
mapping, by the processor, the detected vulnerabilities to each of the plurality of nodes within the sub-graphs, wherein each vulnerability is associated with a severity score and a frequency score; and
computing, by the processor, the vulnerability score for each node in the sub-graph, wherein the vulnerability score is a heuristic function of the severity score and the frequency score, and wherein the heuristic function corresponds to one of a polynomial and non-polynomial function normalized by a total count of relevant plurality of prompts.

18. The method of claim 11, wherein extracting the probabilistic vulnerable templates corresponding to the plurality of prompts based on the computed vulnerability score, comprises:
extracting, by the processor, a set of prompts from among the plurality of prompts indicated as vulnerable based on previously computed vulnerability scores;
generating, by the processor, a tree data structure for each of the extracted set of prompts, wherein the generated tree structure corresponds to a dependency parse tree, extracted from a neural network-based models;
clustering, by the processor, the generated tree data structure to create clusters based on semantic similarity, and probabilistic vulnerabilities associated with the prompts;
generating, by the processor, a high-level structure for each cluster of prompts, wherein the high-level structure is used during run-time for vulnerability detection;
transforming, by the processor, each prompt into a representation for clustering by extracting syntactic structures using dependency parse trees and generating semantic representations as vectorized embeddings using transformer-based neural network models;
merging, by the processor, the syntactic representation, and semantic representations of the prompts, along with the associated vulnerability scores, into an n-dimensional matrix, wherein the n-dimensionality matrix is determined by an axis of representation;
identifying, by the processor, the closest matching template by aligning the merged syntactic representation and semantic representations with the n-dimensional matrix; and
mapping, by the processor, the identified closest matching template to a corresponding sub-graph of the knowledge graph (KG), wherein the sub-graph corresponds to components associated with the vulnerability template.

19. The method of claim 11, wherein generating the code snippets for the received input data based on the selected at least one vulnerable template comprises:
retrieving, by the processor, a high-level node corresponding to the received input data using the probabilistic function;
iteratively updating, by the processor, subsequent nodes to form an updated sub-graph, the subsequent nodes are determined based on a semantic relevance to the high-level node;
recursively computing, by the processor, semantic scores between the updated sub-graph and the received input data, wherein the recursive computation continues until a constant semantic score in the semantic scores is detected;
extracting, by the processor, largest relevant sub-graph based on the constant semantic score, wherein the largest relevant sub-graph comprises the high-level tasks, the low-level tasks, and the associated components;
computing, by the processor, a template risk score as a weighted function of at least one of the vulnerability scores associated with nodes, the frequency of occurrence of the template in historical projects, the probability of vulnerability occurrence and the severity score of a business domain;
ranking, by the processor, the plurality of alternate components using a ranking function based on the computed template risk score; and
generating, by the processor, the code snippets for the received input data based on the ranked plurality of alternate components, wherein the generated code snippets comprise the ranked plurality of alternate components.

20. A non-transitory computer readable medium comprising a processor-executable instructions that cause a processor to:
receive an input data associated with a software project from a plurality of data sources, wherein the input data comprises high-level tasks and low-level tasks associated with the software project;
generate a knowledge graph for the received input data based on a pre-stored historical data, wherein the knowledge graph comprises a plurality of nodes representing the high-level tasks, the low-level tasks, and associated components, and the associated components comprise at least one of software packages and libraries;
extract sub-graphs from the knowledge graph by parsing relationships between the plurality of nodes, wherein the sub-graphs represent a plurality of clusters of tasks and the associated components;
transform the extracted sub-graphs into a plurality of prompts for a Large Language Model (LLM), wherein the plurality of prompts is transformed into natural language statements;
compute a vulnerability score for the plurality of prompts based on a vulnerability, a severity, and a frequency of occurrence of a probabilistic vulnerable template in historical software projects and a probability of the vulnerability occurring, wherein the vulnerability score is mapped to the plurality of nodes in the sub-graphs;
extract probabilistic vulnerable templates corresponding to the plurality of prompts based on the computed vulnerability score;
create a customized priority pipeline for the extracted probabilistic vulnerable templates, wherein customized priority pipeline comprises a plurality of alternate components;
select at least one vulnerable template with a highest vulnerability score based on probabilistic functions, wherein the highest vulnerability score indicates highest level of detected vulnerabilities;
generate code snippets or recommendations for the received input data based on the selected at least one vulnerable template, wherein the code snippets correspond to zero vulnerabilities and wherein the code snippets comprise the alternate components for the received input data; and
output the generated code snippets to a software development environment.
